(19) United States
(12) Patent Application Publication
(10) Pub. No.: US 2014/0322602 A1
(43) Pub. Date: Oct. 30, 2014

(54) ELECTRODE MATERIAL, ELECTRODE-FORMING PASTE, ELECTRODE PLATE, LITHIUM ION BATTERY, AND METHOD OF PRODUCING ELECTRODE MATERIAL

(71) Applicant: SUMITOMO OSAKA CEMENT CO., LTD., Tokyo (JP)

(72) Inventors: Akinori YAMAZAKI, Tokyo (JP); Ryuuta YAMAYA, (US); Satoru OSHITARI, Tokyo (JP); Hirofumi YASUMIISHI, Tokyo (JP); Masataka OYAMA, Tokyo (JP)

(73) Assignee: SUMITOMO OSAKA CEMENT CO., LTD., Tokyo (JP)

(21) Appl. No.: 14/260,606

(22) Filed: Apr. 24, 2014

(30) Foreign Application Priority Data
Apr. 30, 2013 (JP) 2013-095804

(51) Int. Cl. H01M 4/36; H01M 4/1391; H01M 4/04

(52) U.S. Cl. CPC H01M 4/366; H01M 4/0402; H01M 4/1391; H01M 2004/028
USPC 429/220; 429/221; 427/122

(57) ABSTRACT

An electrode material includes surface-coated LiₓA_{y}D_{z}PO₄ particles that contain Fe on surfaces of LiₓA_{y}D_{z}PO₄ (wherein A represents one or two or more elements selected from the group consisting of Co, Mn, Ni, Cu, and Cr; D represents one or two or more elements selected from the group consisting of Mg, Ca, Sr, Ba, Ti, Zn, B, Al, Ga, In, Si, Ge, Sc, Y, and rare earth elements; 0<x≦2; 0<y≦1; and 0≦z≦1.5) particles and include a carbon coating film with which the surfaces of the LiₓA_{y}D_{z}PO₄ particles containing Fe are coated, in which the surface-coated LiₓA_{y}D_{z}PO₄ particles have a Li elution amount of 200 ppm to 700 ppm and a P elution amount of 500 ppm to 2000 ppm when being dipped in a sulfuric acid solution (pH=4) for 24 hours.

### BACKGROUND OF THE INVENTION

1. Field of the Invention

The present invention relates to an electrode material, an electrode-forming paste, an electrode plate, a lithium ion battery, and a method of producing an electrode material, particularly, to an electrode material and an electrode-forming paste which are suitably used for a cathode for a lithium ion battery, an electrode plate, a lithium ion battery including the electrode plate, and a method of producing an electrode material.

2. Description of Related Art

Recently, along with the rapid progress in the development of clean energy techniques, the development of techniques aimed at an earth-friendly society has been progressing, for example, the wide use of post-petroleum, zero-emission, and power-saving products. In particular, recently, secondary batteries which are used for high-capacity storage batteries, portable electronic equipment, or the like and can supply energy for electric vehicles or in cases of emergencies have been in the limelight.

As such secondary batteries, for example, lead storage batteries, alkali storage batteries, or lithium ion batteries are known.

In particular, lithium ion batteries which are non-aqueous electrolytic solution secondary batteries can be reduced in size and weight and increased in capacity and have superior properties such as high output and high energy density. Therefore, lithium ion batteries have been commercialized as a high-output power supply of electric vehicles, electric tools, or the like, and next-generation lithium ion battery materials have been actively developed all over the world.

In addition, recently, a home energy management system (HEMS), which is a collaboration of energy techniques and housing techniques, has been used. A smart energy-saving system has attracted attention as well, in which the optimization of automatic control, electric power supply and demand, and the like is controlled by integrating information relating to home electric appliances such as smart appliances, electric vehicles, or photovoltaic power generators and control systems thereof.

As a cathode-active material for a lithium ion battery which has been put into practice, LiCoO₂ or LiMnO₂ is commonly used. However, Co is a rare resource which is unevenly distributed on earth and thus, for example, when being required to be used in a large amount as a cathode material, has a problem in that the production cost of a product is increased and stable supply is difficult. As an alternative cathode-active material to LiCoO₂, the research and development of a cathode-active material such as LiMn₂O₄ having a spinel crystal structure, LiNi_{1/3}Mn_{1/3}Co_{1/3}O₂ having a ternary system composition, lithium iron oxide (LiFeO₂) which is an iron-based compound, lithium iron phosphate (LiFePO₄), or lithium manganese phosphate (LiMnPO₄) have actively progressed.

Among these cathode-active materials, olivine-based cathode-active materials have a problem of low electron conductivity.

As an electrode material with improved electron conductivity, for example, an electrode material and a production method thereof are disclosed, the electrode material being obtained by allowing primary particles formed of LiₓA_{y}D_{z}PO₄ (wherein A represents at least one element selected from the group consisting of Cr, Mn, Fe, Co, Ni, and Cu; D represents at least one element selected from the group consisting of Mg, Ca, Sr, Ba, Ti, Zn, B, Al, Ga, In, Si, Ge, Sc, Y, and rare earth elements; 0<x≦2; 0<y≦1; and 0≦z<1.5) to aggregate such that secondary particles are formed and allowing an electron conductive material such as carbon to be interposed between the secondary particles (refer to Japanese Laid-Open Patent Publication Nos. 2004-014340 and 2004-014341).

In addition, an electrode material including a manganese oxide layer between LiFePO₄ or LiMnPO₄ and a carbon layer is disclosed, in which LiFePO₄ or LiMnPO₄ is coated with the carbon layer (refer to Japanese Laid-Open Patent Publication No. 2010-533354).

### SUMMARY OF THE INVENTION

In the electrode materials disclosed in Japanese Laid-Open Patent Publication Nos. 2004-014340, 2004-014341, and 2010-533354, the initial capacity is certainly improved, but there is a problem in that the battery capacity deteriorates in cycling characteristics in which a charged state is maintained for a long period of time and charging and discharging are repeatedly performed. Accordingly, in these electrode materials, improvement in durability has been required.

Examples of a factor causing such deterioration in durability include elution of metal impurities other than Li from an electrode material into an electrolytic solution. That is, when metal impurities other than Li are eluted into an electrolytic solution, the metal impurities are electrodeposited on a surface of an anode, a deposition layer (solid electrolyte interphase; SEI) present on the surface of the anode is destroyed, and capacity deterioration occurs due to SEI reorganization. In addition, the penetration of the electrodeposited metal impurities into a separator is one of the causes of short-circuiting in a battery.

In addition, an electrode material of the related art contains a compound derived from the electrode material. For example, LiFePO₄ contains a Fe compound and LiMnPO₄ contains a Mn compound. Therefore, these compounds have a problem of being easily eluted as metal impurities.

In addition, in the electrode material disclosed in Japanese Laid-Open Patent Publication No. 2010-533354, in order to improve the electron conductivity of an olivine-based cathode-active material, a Mn compound such as manganese oxide may be mixed with the electrode material. Accordingly, an electrode material in which the elution of metal impurities other than Li is suppressed is required.

The present invention has been made in order to solve the above-described problems, and an object thereof is to provide an electrode material and an electrode-forming paste capable of realizing stable charge-discharge cycling characteristics and high durability by suppressing the elution of metal impurities other than Li from an electrode material; an electrode plate; a lithium ion battery; and a method of producing an electrode material.

As a result of thorough investigation for solving the above-described problems, the present inventors found that, when surface-coated LiₓA_{y}D_{z}PO₄ particles are heated at a temperature of 40° C. to 500° C., the elution of metal impurities other than Li is suppressed, in which the surface-coated LiₓA_{y}D_{z}PO₄ particles contain Fe on surfaces of LiₓA_{y}D_{z}PO₄ (wherein A represents one or two or more elements selected from the group consisting of Co, Mn, Ni, Cu, and Cr; D represents one or two or more elements selected from the group consisting of Mg, Ca, Sr, Ba, Ti, Zn, B, Al, Ga, In, Si, Ge, Sc, Y, and rare earth elements; 0<x≦2; 0<y≦1; and 0≦z≦1.5) particles and include a carbon coating film with which the surfaces of the LiₓA_{y}D_{z}PO₄ particles containing Fe are coated. Based on this finding, the invention has been completed.

That is, according to a first aspect of the invention, an electrode material is provided including surface-coated LiₓA_{y}D_{z}PO₄ particles that contain Fe on surfaces of LiₓA_{y}D_{z}PO₄ (wherein A represents one or two or more elements selected from the group consisting of Co, Mn, Ni, Cu, and Cr; D represents one or two or more elements selected from the group consisting of Mg, Ca, Sr, Ba, Ti, Zn, B, Al, Ga, In, Si, Ge, Sc, Y, and rare earth elements; 0<x≦2; 0<y≦1; and 0≦z≦1.5) particles and include a carbon coating film with which the surfaces of the LiₓA_{y}D_{z}PO₄ particles containing Fe are coated, in which the surface-coated LiₓA_{y}D_{z}PO₄ particles have a Li elution amount of 200 ppm to 700 ppm and a P elution amount of 500 ppm to 2000 ppm when being dipped in a sulfuric acid solution having a pH of 4 for 24 hours.

According to a second aspect of the invention, an electrode material is provided including aggregated particles that are obtained by allowing surface-coated LiₓA_{y}D_{z}PO₄ particles to aggregate, in which the surface-coated LiₓA_{y}D_{z}PO₄ particles contain Fe on surfaces of LiₓA_{y}D_{z}PO₄ (wherein A represents one or two or more elements selected from the group consisting of Co, Mn, Ni, Cu, and Cr; D represents one or two or more elements selected from the group consisting of Mg, Ca, Sr, Ba, Ti, Zn, B, Al, Ga, In, Si, Ge, Sc, Y, and rare earth elements; 0<x≦2; 0<y≦1; and 0≦z≦1.5) particles and include a carbon coating film with which the surfaces of the LiₓA_{y}D_{z}PO₄ particles containing Fe are coated, and the aggregated particles have a Li elution amount of 200 ppm to 700 ppm and a P elution amount of 500 ppm to 2000 ppm when being dipped in a sulfuric acid solution having a pH of 4 for 24 hours.

It is preferable that the electrode materials according to the first and second aspects further include manganese oxide.

According to a third aspect of the invention, an electrode-forming paste is provided, including: the above-described electrode material; a conductive auxiliary agent; a binding agent; and a solvent.

According to a fourth aspect of the invention, an electrode plate is provided which is obtained by forming a cathode material layer containing the above-described electrode material on a current collector.

According to a fifth aspect of the invention, a lithium ion battery is provided including the above-described electrode plate.

According to a sixth aspect of the invention, a method of producing an electrode material is provided, including: mixing LiₓA_{y}D_{z}PO₄ (wherein A represents one or two or more elements selected from the group consisting of Co, Mn, Ni, Cu, and Cr; D represents one or two or more elements selected from the group consisting of Mg, Ca, Sr, Ba, Ti, Zn, B, Al, Ga, In, Si, Ge, Sc, Y, and rare earth elements; 0<x≦2; 0<y≦1; and 0≦z≦1.5) particles, an organic compound, and either or both of an iron source and a precursor material of lithium iron phosphate with a solvent to prepare a slurry; drying the slurry to prepare a dry material; baking the dry material in a non-oxidizing atmosphere to prepare surface-coated LiₓA_{y}D_{z}PO₄ particles or aggregated particles, in which the surface-coated LiₓA_{y}D_{z}PO₄ particles contain Fe on surfaces of the LiₓA_{y}D_{z}PO₄ particles and include a carbon coating film with which the surfaces of the LiₓA_{y}D_{z}PO₄ particles containing Fe are coated, and the aggregated particles are obtained by allowing the surface-coated LiₓA_{y}D_{z}PO₄ particles to aggregate; and heating either the surface-coated LiₓA_{y}D_{z}PO₄ particles or the aggregated particles at a temperature of 40° C. to 500° C. for 0.1 hours to 1000 hours.

The electrode material according to the first or second aspect includes surface-coated LiₓA_{y}D_{z}PO₄ particles or aggregated particles, in which the surface-coated LiₓA_{y}D_{z}PO₄ particles contain Fe on surfaces of LiₓA_{y}D_{z}PO₄ (wherein A represents one or two or more elements selected from the group consisting of Co, Mn, Ni, Cu, and Cr; D represents one or two or more elements selected from the group consisting of Mg, Ca, Sr, Ba, Ti, Zn, B, Al, Ga, In, Si, Ge, Sc, Y, and rare earth elements; 0<x≦2; 0<y≦1; and 0≦z≦1.5) particles and include a carbon coating film with which the surfaces of the LiₓA_{y}D_{z}PO₄ particles containing Fe are coated, and the aggregated particles are obtained by allowing surface-coated LiₓA_{y}D_{z}PO₄ particles to aggregate. In the electrode material, the surface-coated LiₓA_{y}D_{z}PO₄ particles or the aggregated particles have a Li elution amount of 200 ppm to 700 ppm and a P elution amount of 500 ppm to 2000 ppm when being dipped in a sulfuric acid solution having a pH of 4 for 24 hours. As a result, the elution of metal impurities other than Li from the surface-coated LiₓA_{y}D_{z}PO₄ particles or the aggregated particles can be suppressed.

The electrode-forming paste according to the third aspect includes: the above-described electrode material; a conductive auxiliary agent; a binding agent; and a solvent. As a result, when an electrode is obtained by forming a cathode material layer containing an electrode material on a current collector using the electrode-forming paste, the elution of metal impurities other than Li in this electrode can be suppressed.

The electrode plate according to the fourth aspect is obtained by forming a cathode material layer containing the above-described electrode material on a current collector. As a result, the elution of metal impurities other than Li can be suppressed.

The lithium ion battery according to the fifth aspect includes the above-described electrode plate. As a result, the elution of metal impurities other than Li can be suppressed, and thus the durability of a lithium ion battery can be improved.

The method of producing an electrode material according to the sixth aspect includes: mixing LiₓA_{y}D_{z}PO₄ (wherein A represents one or two or more elements selected from the group consisting of Co, Mn, Ni, Cu, and Cr; D represents one or two or more elements selected from the group consisting of Mg, Ca, Sr, Ba, Ti, Zn, B, Al, Ga, In, Si, Ge, Sc, Y, and rare earth elements; 0<x≦2; 0<y≦1; and 0≦z≦1.5) particles, an organic compound, and either or both of an iron source and a precursor material of lithium iron phosphate with a solvent to prepare a slurry; drying the slurry to prepare a dry material; baking the dry material in a non-oxidizing atmosphere to prepare surface-coated LiₓA_{y}D_{z}PO₄ particles or aggregated particles, in which the surface-coated LiₓA_{y}D_{z}PO₄ particles contain Fe on surfaces of the LiₓA_{y}D_{z}PO₄ particles and include a carbon coating film with which the surfaces of the LiₓA_{y}D_{z}PO₄ particles containing Fe are coated, and the aggregated particles are obtained by allowing the surface-coated LiₓA_{y}D_{z}PO₄ particles to aggregate; and heating either the surface-coated LiₓA_{y}D_{z}PO₄ particles or the aggregated particles at a temperature of 40° C. to 500° C. for 0.1 hours to 1000 hours. As a result, an electrode material capable of suppressing the elution of metal impurities other than Li can be easily produced.

### DETAILED DESCRIPTION OF THE INVENTION

Embodiments of an electrode material, an electrode-forming paste, an electrode plate, a lithium ion battery, and a method of producing an electrode material according to the invention will be described.

Although these embodiments are merely specific examples for better understanding of the scope of the invention, the invention is not limited thereto unless specified otherwise.

### Electrode Material

An electrode material according to an embodiment of the invention is an electrode material according to the following (1) or (2).

(1) An electrode material including surface-coated LiₓA_{y}D_{z}PO₄ particles that contain Fe on surfaces of LiₓA_{y}D_{z}PO₄ (wherein A represents one or two or more elements selected from the group consisting of Co, Mn, Ni, Cu, and Cr; D represents one or two or more elements selected from the group consisting of Mg, Ca, Sr, Ba, Ti, Zn, B, Al, Ga, In, Si, Ge, Sc, Y, and rare earth elements; 0<x≦2; 0<y≦1; and 0≦z≦1.5) particles and include a carbon coating film with which the surfaces of the LiₓA_{y}D_{z}PO₄ particles containing Fe are coated, in which the surface-coated LiₓA_{y}D_{z}PO₄ particles have a Li elution amount of 200 ppm to 700 ppm and a P elution amount of 500 ppm to 2000 ppm when being dipped in a sulfuric acid solution having a pH of 4 for 24 hours.

(2) An electrode material including aggregated particles that are obtained by allowing surface-coated LiₓA_{y}D_{z}PO₄ particles to aggregate, in which the surface-coated LiₓA_{y}D_{z}PO₄ particles contain Fe on surfaces of LiₓA_{y}D_{z}PO₄ (wherein A represents one or two or more elements selected from the group consisting of Co, Mn, Ni, Cu, and Cr; D represents one or two or more elements selected from the group consisting of Mg, Ca, Sr, Ba, Ti, Zn, B, Al, Ga, In, Si, Ge, Sc, Y, and rare earth elements; 0<x≦2; 0<y≦1; and 0≦z≦1.5) particles and include a carbon coating film with which the surfaces of the LiₓA_{y}D_{z}PO₄ particles containing Fe are coated, and the aggregated particles have a Li elution amount of 200 ppm to 700 ppm and a P elution amount of 500 ppm to 2000 ppm when being dipped in a sulfuric acid solution having a pH of 4 for 24 hours.

“The aggregated particles that are obtained by allowing surface-coated LiₓA_{y}D_{z}PO₄ particles to aggregate” described herein includes both states of: a state where carbon coating films of the surface-coated LiₓA_{y}D_{z}PO₄ particles are in contact with each other; a state where the LiₓA_{y}D_{z}PO₄ particles are in contact with each other. However, the state where the carbon coating films are in contact with each other is more preferable.

This contact state is not particularly limited, but it is preferable that the LiₓA_{y}D_{z}PO₄ particles or the carbon coating films be strongly connected to form aggregates in a neck shape in which the contact area is small and the contact portion has a small cross-sectional area. That is, it is preferable that the contact area be decreased because gaps are formed inside aggregated particles, and thus the lithium ions are easily diffused and permeated. In addition, it is more preferable that the contact portion have a neck shape having a small cross-section because a structure in which channel-shaped (net-shaped) gaps are three-dimensionally spread is formed inside the aggregates.

The electrode material according to (2) is different from the electrode material according to (1), in that “aggregated particles are obtained by allowing surface-coated LiₓA_{y}D_{z}PO₄ particles to aggregate”. The other points are entirely the same.

Hereinafter, the electrode material according to (1) will be described, and different points of the electrode material according to (2) from those of the electrode material according to (1) will be appropriately described.

In LiₓA_{y}D_{z}PO₄ (wherein A represents one or two or more elements selected from the group consisting of Co, Mn, Ni, Cu, and Cr; D represents one or two or more elements selected from the group consisting of Mg, Ca, Sr, Ba, Ti, Zn, B, Al, Ga, In, Si, Ge, Sc, Y, and rare earth elements; 0<x≦2; 0<y≦1; and 0≦z≦1.5), which is a major component of the surface-coated LiₓA_{y}D_{z}PO₄ particles, it is preferable that A represent Co, Mn, or Ni and D represent Mg, Ca, Sr, Ba, Ti, Zn, or Al from the viewpoints of high discharge potential and the like.

The rare earth elements described herein refer to 15 lanthanum-based elements of La, Ce, Pr, Nd, Pm, Sm, Eu, Gd, Tb, Dy, Ho, Er, Tm, Yb, and Lu.

This Fe has a function as a catalyst for efficiently forming the carbon coating film on the surfaces of the LiₓA_{y}D_{z}PO₄ particles and is considered to have an effect of promoting the insertion and extraction of Li. Accordingly, Fe may be present on the surfaces such that the carbon coating film is formed on the surfaces of the LiₓA_{y}D_{z}PO₄ particles to the extent that a desired electron conductivity is obtained and to the extent that properties of the LiₓA_{y}D_{z}PO₄ particles are not excessively inhibited. This Fe may be present as Fe alone or a Fe compound.

The amount of Fe may be appropriately adjusted. For example, when the electrode material according to the embodiment is measured by inductively coupled plasma (ICP) spectrometry, the Fe content is preferably 0.03 mol to 0.09 mol, more preferably 0.04 mol to 0.08 mol, and still more preferably 0.05 mol to 0.07 mol with respect to 1 mol of P.

When the Fe content in the surfaces of the LiₓA_{y}D_{z}PO₄ particles is in the above-described range, the carbon coating film is efficiently formed on the surfaces of the LiₓA_{y}D_{z}PO₄ particles, and the properties of the LiₓA_{y}D_{z}PO₄ particles are not excessively inhibited.

The surface-coated LiₓA_{y}D_{z}PO₄ particles have a Li elution amount of 200 ppm to 700 ppm and a P elution amount of 500 ppm to 2000 ppm when being dipped in a sulfuric acid solution (pH=4) for 24 hours.

In order to obtain the Li elution amount and the P elution amount, the particles are put into a sulfuric acid solution having a mass ten times that of the particles and a pH of 4 and held at 25° C., are stirred, and are dipped therein at 25° C. for 24 hours. After 24 hours, the elution amounts of Li and P eluted from the particles in the sulfuric acid solution are measured.

As a method of measuring the Li elution amount and the P elution amount, ICP spectrometry is preferable because the detection sensitivity is high and multi-element simultaneous determination can be performed with high sensitivity.

The Li elution amount and the P elution amount of the surface-coated LiₓA_{y}D_{z}PO₄ particles can be controlled by heating the surface-coated LiₓA_{y}D_{z}PO₄ particles at 40° C. to 500° C.

The reason is as follows. The surface-coated LiₓA_{y}D_{z}PO₄ particles are heated at 40° C. to 500° C. to apply heat energy of room temperature or higher thereto. Accordingly, Li and P contained in the surface-coated LiₓA_{y}D_{z}PO₄ particles are eluted from the inside of the particles, and thus Li, a Li compound, P, and a P compound which are eluted are present in the surfaces of the particles.

When the surface-coated LiₓA_{y}D_{z}PO₄ particles are dipped in the sulfuric acid solution (pH=4), Li, a Li compound, P, and a P compound which are presumed to be present in the surfaces are preferentially eluted in the sulfuric acid solution (pH=4). As a result, the elution of metal impurities other than Li is suppressed.

The reason for limiting the Li elution amount to be 200 ppm to 700 ppm is as follows. In this range, an appropriate amount of Li or a Li compound is present on the surfaces of the surface-coated LiₓA_{y}D_{z}PO₄ particles.

When the Li elution amount is less than 200 ppm, the amount of Li or the Li compound on the surfaces of the surface-coated LiₓA_{y}D_{z}PO₄ particles is decreased. Accordingly, the elution of metal impurities other than Li from the particles cannot be suppressed. On the other hand, when the Li elution amount is greater than 700 ppm, the amount of Li or the Li compound on the surfaces of the surface-coated LiₓA_{y}D_{z}PO₄ particles is increased, and thus the thickness of Li or the Li compound covering the surfaces of the particles is excessively increased. As a result, when the surface-coated LiₓA_{y}D_{z}PO₄ particles are applied to a lithium ion battery, the insertion and extraction of Li are inhibited, and sufficient charge-discharge characteristics cannot be exhibited.

The reason for limiting the P elution amount to be 500 ppm to 2000 ppm is as follows. In this range, similarly to the case of the Li elution amount, an appropriate amount of P or a P compound is present on the surfaces of the surface-coated LiₓA_{y}D_{z}PO₄ particles.

When the P elution amount is less than 500 ppm, the amount of P or the P compound on the surfaces of the surface-coated LiₓA_{y}D_{z}PO₄ particles is decreased. Accordingly, the elution of metal impurities other than Li from the particles cannot be suppressed. On the other hand, when the P elution amount is greater than 2000 ppm, the amount of P or the P compound on the surfaces of the surface-coated LiₓA_{y}D_{z}PO₄ particles is increased, and thus the thickness of P or the P compound covering the surfaces of the particles is excessively increased. As a result, when the surface-coated LiₓA_{y}D_{z}PO₄ particles are applied to a lithium ion battery, the insertion and extraction of Li are inhibited, and sufficient charge-discharge characteristics cannot be exhibited.

The average particle size of the surface-coated LiₓA_{y}D_{z}PO₄ particles is preferably 0.01 μm to 20 μm and more preferably 0.02 μm to 5 μm.

The reason for limiting the average particle size of the surface-coated LiₓA_{y}D_{z}PO₄ particles to the above-described range is as follows. When the average particle size is less than 0.01 μm, it is difficult to sufficiently coat the surfaces of the LiₓA_{y}D_{z}PO₄ particles containing Fe with the carbon coating film, and thus the discharge capacity during high-speed charging and discharging is decreased. As a result, it is difficult to realize sufficient charge-discharge performance. On the other hand, when the average particle size is greater than 20 μm, the internal resistance of the LiₓA_{y}D_{z}PO₄ particles is increased, and thus the discharge capacity during high-speed charging and discharging is insufficient.

In order to obtain the average particle size of the surface-coated LiₓA_{y}D_{z}PO₄ particles, the particles are observed using a scanning electron microscope (SEM) or the like, a predetermined number of surface-coated LiₓA_{y}D_{z}PO₄ particles, for example, 200 or 100 surface-coated LiₓA_{y}D_{z}PO₄ particles are selected, longest linear portions (maximum lengths) of the respective surface-coated LiₓA_{y}D_{z}PO₄ particles are measured, and the average value of the measured values is calculated.

As a method other than the above-described method, the following method can be used. The surface-coated LiₓA_{y}D_{z}PO₄ particles are dispersed in a solvent such as water to obtain a dispersion, and the number average particle size of the dispersion is measured using a laser diffraction scattering particle size distribution analyzer or the like.

On the other hand, when the surface-coated LiₓA_{y}D_{z}PO₄ particles aggregate to form aggregated particles, the average particle size of the aggregated particles is preferably 0.5 μm to 100 μm and more preferably 1 μm to 20 μm.

The reason for limiting the average particle size of the aggregated particles to the above-described range is as follows. When the average particle size of the aggregated particles is less than 0.5 μm, the aggregated particles are excessively small and easily moved, and thus are difficult to handle during the preparation of an electrode-forming paste. On the other hand, in a case where the average particle size of the aggregated particles is greater than 100 μm, when a cathode material layer containing this electrode material is formed on a current collector to prepare an electrode plate, there is a high possibility that aggregated particles having a size greater than the thickness of the dried cathode material layer may be present. Accordingly, it is difficult to maintain the uniformity in the thickness of the cathode material layer.

Similarly to the method of measuring the average particle size of the surface-coated LiₓA_{y}D_{z}PO₄ particles, the average particle size of the aggregated particles may be obtained by measuring particle sizes of a predetermined number of aggregated particles using a scanning electron microscope (SEM) or the like and obtaining the average value of the measured particle sizes, or may be obtained by measuring the number average particle size of the aggregated particles in a dispersion using a laser diffraction scattering particle size distribution analyzer or the like.

The volume density of these aggregates can be measured using a mercury porosimeter, and is preferably 40 vol % to 95 vol % and more preferably 60 vol % to 90 vol % with respect to the volume density of a case where the aggregated particles are solid.

By controlling the volume density of the aggregated particles to be 40 vol % or greater as described above, the aggregated particles are densified, and the strength of the aggregated particles is increased. For example, when the aggregated particles, a conductive auxiliary agent, a binder, and a solvent are mixed to prepare an electrode-forming paste, the aggregated particles are not easily collapsed. As a result, an increase in the viscosity of the electrode-forming paste is suppressed, and the fluidity is maintained. Thus, the coating property is improved, and the filling property of the electrode material during the coating of the electrode-forming paste can be improved.

In addition, in the surface-coated LiₓA_{y}D_{z}PO₄ particles, in order to uniformly perform a reaction, which relates to the insertion and extraction of lithium ions when being used as an electrode material of a lithium ion battery, on the entire surfaces of the surface-coated LiₓA_{y}D_{z}PO₄ particles, it is preferable that 80% or greater and preferably 90% or greater of the surfaces of the surface-coated LiₓA_{y}D_{z}PO₄ particles be coated with the carbon coating film.

The coverage of the carbon coating film can be measured using a transmission electron microscope (TEM) or an energy-dispersive X-ray spectrometer (EDX). It is not preferable that the coverage of the carbon coating film be less than 80% because a covering effect of the carbon coating film is insufficient. In addition, since the insertion and extraction reaction of lithium ions are performed on the surfaces of the surface-coated LiₓA_{y}D_{z}PO₄ particles, the resistance to the reaction relating to the insertion and extraction reaction of lithium ions is increased on portions where the carbon coating film is not formed, and voltage drop is significant in the last stage of discharging.

The thickness of the carbon coating film is preferably 0.1 nm to 20 nm.

The reason for limiting the thickness of the carbon coating film to the above-described range is as follows. When the thickness is less than 0.1 nm, the thickness of the carbon coating film is excessively small, and it is difficult to form a film having a desired resistance value. As a result, the conductivity is decreased, and it is difficult to secure the conductivity as an electrode material. On the other hand, when the thickness is more than 20 nm, battery activity, for example, the battery capacity per unit mass of an electrode material is decreased.

The amount of carbon in the carbon coating film is preferably 0.5 parts by mass to 5 parts by mass and more preferably 1 part by mass to 2 parts by mass with respect to 100 parts by mass of the LiₓA_{y}D_{z}PO₄ particles.

The reason for limiting the amount of carbon in the carbon coating film to the above-described range is as follows. When the amount of carbon is less than 0.5 parts by mass, the coverage of the carbon coating film is less than 80%. Therefore, when a battery is formed, the discharge capacity at a high charge-discharge rate is decreased, and it is difficult to realize sufficient charge-discharge rate performance. On the other hand, when the amount of carbon is greater than 5 parts by mass, carbon is present on the surfaces of the LiₓA_{y}D_{z}PO₄ particles in an amount greater than an amount of carbon for forming the carbon coating film which is the minimum amount for obtaining conductivity. As a result, the battery capacity of a lithium ion battery per unit mass of the LiₓA_{y}D_{z}PO₄ particles is decreased more than necessary.

The shape of the surface-coated LiₓA_{y}D_{z}PO₄ particles is not particularly limited, but is preferably spherical because an electrode material is easily formed of spherical particles, particularly, true-spherical secondary particles.

The reason why the spherical shape is preferable is as follows. When the surface-coated LiₓA_{y}D_{z}PO₄ particles, a conductive auxiliary agent, a binder resin (binder), and a solvent are mixed with each other to prepare an electrode-forming paste, the amount of the solvent can be reduced, and the electrode-forming paste is easily coated on a current collector. In addition, it is preferable that the shape of the surface-coated LiₓA_{y}D_{z}PO₄ particles be spherical because the surface area of the surface-coated LiₓA_{y}D_{z}PO₄ particles is minimum, the addition amount of a binder resin (binder) added can be minimized, and the internal resistance of the obtained cathode can be decreased.

Further, when the shape of the surface-coated LiₓA_{y}D_{z}PO₄ particles is spherical, particularly true-spherical, the surface-coated LiₓA_{y}D_{z}PO₄ particles are easily close-packed. Therefore, the filling amount of a cathode material per unit volume is increased, the electrode density can be increased, and thus the capacity of a lithium ion battery can be increased.

It is preferable that the electrode material according to the embodiment, that is, the surface-coated LiₓA_{y}D_{z}PO₄ particles or the aggregated particles obtained by allowing the surface-coated LiₓA_{y}D_{z}PO₄ particles to aggregate contain manganese oxide.

The content of manganese oxide is not particularly limited and may be appropriately adjusted so as to improve the electron conductivity. For example, the content of manganese oxide in the electrode material is preferably 1 ppm or greater and 1.0% by mass or less.

The distribution state of manganese oxide is not particularly limited. Manganese oxide may be distributed inside the surface-coated LiₓA_{y}D_{z}PO₄ particles or on the surfaces of the surface-coated LiₓA_{y}D_{z}PO₄ particles.

### Method of Producing Electrode Material

A method of producing an electrode material includes: a slurry-preparing process of mixing the above-described LiₓA_{y}D_{z}PO₄ particles, an organic compound, and either or both of an iron source and a precursor material of lithium iron phosphate with a solvent to prepare a slurry; a baking process of drying the slurry to prepare a dry material and baking the dry material in a non-oxidizing atmosphere to prepare surface-coated LiₓA_{y}D_{z}PO₄ particles or aggregated particles, in which the surface-coated LiₓA_{y}D_{z}PO₄ particles contain Fe on surfaces of the LiₓA_{y}D_{z}PO₄ particles and include a carbon coating film with which the surfaces of the LiₓA_{y}D_{z}PO₄ particles containing Fe are coated, and the aggregated particles are obtained by allowing the surface-coated LiₓA_{y}D_{z}PO₄ particles to aggregate; and a heat treatment process of heating either the surface-coated LiₓA_{y}D_{z}PO₄ particles or the aggregated particles at a temperature of 40° C. to 500° C. for 0.1 hours to 1000 hours.

Next, this production method will be described in detail.

### Slurry-Preparing Process

In the slurry-preparing process, the above-described LiₓA_{y}D_{z}PO₄ particles, an organic compound, and either or both of an iron source and a precursor material of lithium iron phosphate are mixed with a solvent to prepare a slurry.

First, the LiₓA_{y}D_{z}PO₄ particles are prepared.

As a method of preparing the LiₓA_{y}D_{z}PO₄ particles, a method of the related art such as a solid-phase method, a liquid-phase method, or a gas-phase method can be used. In particular, the liquid-phase method is preferable because the particle size can be controlled to a desired size.

When the LiₓA_{y}D_{z}PO₄ particles are prepared using a liquid-phase method, for example, a Li source, an A source, a D source, and a PO₄ source are put into a solvent including water as a major component with a molar ratio (Li source:A source:D source:PO₄ source) of x:y:z:1 and are stirred to obtain a precursor solution of the LiₓA_{y}D_{z}PO₄ particles, and this precursor solution is put into a pressure-resistant container and sealed therein. Next, the precursor solution is hydrothermally treated in a high-temperature and high-pressure environment, for example, at a temperature of 120° C. to 250° C. under a pressure of 0.2 MPa or higher for 1 hour to 24 hours.

In this case, by controlling the temperature, the pressure, and the time during the hydrothermal treatment, the particle size of the LiₓA_{y}D_{z}PO₄ particles can be controlled to a desired size.

As the Li source, for example, one or two or more elements selected from the group consisting of lithium inorganic salts such as lithium hydroxide (LiOH), lithium carbonate (Li₂Co₃), lithium chloride (LiCl), or lithium phosphate (Li₃PO₄) and lithium organic salts such as lithium acetate (LiCH₃COO) or lithium oxalate ((COOLi)₂) are preferably used.

Among these, lithium chloride and lithium acetate are preferable because a uniform solution phase is easily obtained.

As the A source, for example, one or two or more elements selected from the group consisting of a Co source formed of a cobalt compound, a Mn source formed of a manganese compound, a Ni sources formed of a nickel compound, a Cu source formed of a copper compound, and a Cr source formed of a chromium compound are preferable.

As the Co sources, Co salts are preferable, and for example, one or two or more elements selected from the group consisting of cobalt chloride (II) (CoCl₂), cobalt sulfate (II) (CoSO₄), cobalt nitrate (II) (Co(NO₃)₂), cobalt acetate (II) (Co(CH₃COO)₂), and hydrates thereof are preferably used.

As the Mn sources, Mn salts are preferable, and for example, one or two or more elements selected from the group consisting of manganese chloride (II) (MnCl₂), manganese sulfate (II) (MnSO₄), manganese nitrate (II) (Mn (NO₃)₂), manganese acetate (II) (Mn (CH₃COO)₂), and hydrates thereof are preferably used. Among these, manganese sulfate is preferable because a uniform solution phase is easily obtained.

As the Ni sources, Ni salts are preferable, and for example, one or two or more elements selected from the group consisting of nickel chloride (II) (NiCl₂), nickel sulfate (II) (NiSO₄), nickel nitrate (II) (Ni (NO₃)₂), nickel acetate (II) (Ni (CH₃COO)₂), and hydrates thereof are preferably used.

Likewise, as the Cu sources, Cu salts are preferable, and for example, one or two or more elements selected from the group consisting of copper chloride (II) (CuCl₂), copper sulfate (II) (CuSO₄), copper nitrate (II) (Cu(NO₃)₂), copper acetate (II) (Cu(CH₃COO)₂), and hydrates thereof are preferably used.

In addition, as the Cr sources, Cr salts are preferable, and for example, one or two or more elements selected from the group consisting of chromium sulfate (II) (CrSO₄), chromium chloride (III) (CrCl₃), and chromium nitrate (III) (Cr(NO₃)₃) are preferably used.

As the PO₄ source, for example, one or two or more elements selected from the group consisting of phosphoric acids such as orthophosphoric acid (H₃PO₄) or metaphosphoric acid (HPO₃), ammonium dihydrogen phosphate (NH₄H₂PO₄), diammonium hydrogen phosphate ((NH₄)H₂PO₄), ammonium phosphate ((NH₄)₃PO₄), lithium phosphate (Li₃PO₄), dilithium hydrogen phosphate (Li₂HPO₄), lithium dihydrogen phosphate (LiH₂PO₄) and hydrates thereof are preferable.

In particular, orthophosphoric acid, ammonium phosphate, and lithium phosphate are preferable because a uniform solution phase is easily formed.

Next, the LiₓA_{y}D_{z}PO₄ particles, an organic compound, and either or both of an iron source and a precursor material of lithium iron phosphate are mixed with a solvent to prepare a uniform slurry. During mixing, a dispersant may be further added.

Examples of the organic compound include polyvinyl alcohol, polyvinyl pyrrolidone, cellulose, starch, gelatin, carboxymethyl cellulose, methyl cellulose, hydroxymethyl cellulose, hydroxyethyl cellulose, polyacrylic acid, polystyrene sulfonic acid, polyacrylamide, polyvinyl acetate, glucose, fructose, galactose, mannose, maltose, sucrose, lactose, glycogen, pectin, alginic acid, glucomannan, chitin, hyaluronic acid, chondroitin, agarose, polyether, and polyol.

Examples of the polyol include ethylene glycol, propylene glycol, polyethylene glycol, polypropylene glycol, glycerin, and polyglycerin.

As the iron (Fe) source, for example, an iron compound such as iron chloride (II) (FeCl₂), iron sulfate (II) (FeSo₄), or iron acetate (II) (Fe(CH₃COO)₂) and a hydrate thereof; a trivalent iron compound such as iron nitrate (III) (Fe(No₃)₃), iron chloride (III) (FeCl₃), or iron citrate (III) (FeC₆H₅O₇); and lithium iron phosphate can be used.

As the precursor of lithium iron phosphate, a mixture which is obtained by mixing a Li source, a Fe source, and a PO₄ source with a molar ratio (Li source:Fe source:PO₄ source) of 1:1:1 is preferably used.

Since examples of the Li source, the Fe source, and the PO₄ source are the same as described above, the descriptions thereof will not be repeated.

As the solvent with which the LiₓA_{y}D_{z}PO₄ particles, the organic compound, and either or both of the iron source and the precursor material of lithium iron phosphate are mixed, water is preferable. However, other solvents may also be used, and examples thereof include alcohols such as methanol, ethanol, 1-propanol, 2-propanol (isopropyl alcohol; IPA), butanol, pentanol, hexanol, octanol, or diacetone alcohol; esters such as ethyl acetate, butyl acetate, ethyl lactate, propylene glycol monomethyl ether acetate, propylene glycol monoethyl ether acetate, or γ-butyrolactone; ethers such as diethyl ether, ethylene glycol monomethyl ether (methyl cellosolve), ethylene glycol monoethyl ether (ethyl cellosolve), ethylene glycol monobutyl ether (butyl cellosolve), diethylene glycol monomethyl ether, or diethylene glycol monoethyl ether; ketones such as acetone, methyl ethyl ketone (MEK), methyl isobutyl ketone (MIBK), acetylacetone, or cyclohexanone; amides such as dimethyl formamide, N,N-dimethylacetoacetamide, or N-methyl pyrrolidone; and glycols such as ethylene glycol, diethylene glycol, or propylene glycol. These solvents may be used alone or in a combination of two or more kinds.

Regarding a mixing ratio of the LiₓA_{y}D_{z}PO₄ particles and the organic compound, the total amount of the organic compound in terms of the amount of carbon is 0.6 parts by mass to 10 parts by mass and more preferably 0.8 parts by mass to 4.0 parts by mass with respect to 100 parts by mass of the LiₓA_{y}D_{z}PO₄ particles.

When the mixing ratio of the organic compound in terms of the amount of carbon is less than 0.6 parts by mass, the coverage of the carbon coating film, which is formed by heating the organic compound, on the surfaces of the LiₓA_{y}D_{z}PO₄ particles is less than 80%. Therefore, when a battery is formed, the discharge capacity at a high charge-discharge rate is decreased, and it is difficult to realize sufficient charge-discharge rate performance. On the other hand, when the mixing ratio of the organic compound in terms of the amount of carbon is greater than 10 parts by mass, the mixing ratio of the LiₓA_{y}D_{z}PO₄ particles is relatively decreased. Therefore, when a battery is formed, the capacity of the battery is decreased, and the bulk density of the LiₓA_{y}D_{z}PO₄ particles is increased. Accordingly, the electrode density is decreased, and a decrease in the battery capacity of a lithium ion battery per unit volume becomes intolerable.

A mixing ratio of the LiₓA_{y}D_{z}PO₄ particles and either or both of the iron source and the precursor material of lithium iron phosphate (LiFePO₄) only needs to be adjusted such that 80% or greater of the surfaces of the LiₓA_{y}D_{z}PO₄ particles are coated with the carbon coating film.

As an example of the mixing ratio, the mixing ratio of Fe is preferably 0.03 mol to 0.09 mol, more preferably 0.04 mol to 0.08 mol, and still more preferably 0.05 mol to 0.07 mol with respect to 1 mol of P.

More specifically, the mixing ratio of the LiₓA_{y}D_{z}PO₄ particles is preferably 1% by mass to 10% by mass, more preferably 2% by mass to 9% by mass, and still more preferably 3% by mass to 8% by mass with respect to the total mass of the LiₓA_{y}D_{z}PO₄ particles and the LiFePO₄ particles.

A method of mixing the LiₓA_{y}D_{z}PO₄ particles, the organic compound, and either or both of the iron source and the precursor material of lithium iron phosphate with the solvent is not particularly limited as long as these materials are uniformly mixed with this method. For example, a method using a medium stirring type dispersing machine such as a planetary ball mill, a vibration ball mill, a bead mill, a paint shaker, or an attritor is preferable.

During mixing, it is preferable that the LiₓA_{y}D_{z}PO₄ particles be dispersed in the solvent, and then the organic compound be dissolved therein. In this way, the surfaces of the uniformly dispersed LiₓA_{y}D_{z}PO₄ particles are coated with the organic compound.

As a result, by baking the organic compound in the subsequent process, the carbon coating film derived from the organic compound is uniformly formed on the surfaces of the LiₓA_{y}D_{z}PO₄ particles.

### Baking Process

In the baking process, the slurry is dried to prepare a dry material, and the dry material is calcined in a non-oxidizing atmosphere to prepare surface-coated LiₓA_{y}D_{z}PO₄ particles or aggregated particles, in which the surface-coated LiₓA_{y}D_{z}PO₄ particles contain Fe on surfaces of the LiₓA_{y}D_{z}PO₄ particles and include a carbon coating film with which the surfaces of the LiₓA_{y}D_{z}PO₄ particles containing Fe are coated, and the aggregated particles are obtained by allowing the surface-coated LiₓA_{y}D_{z}PO₄ particles to aggregate.

In this step, the slurry is dried to prepare a dry material.

A dry method is not particularly limited as long as the solvent can be removed from the slurry with this method, and examples thereof include a dry method using a drying machine and a spray drying method using a spray dryer or the like.

Examples of the spray drying method include a method of spraying and drying a slurry in the air at a high temperature of 100° C. to 300° C. to prepare a particulate dry material or a granular dry material.

Next, the dry material is calcined in a non-oxidizing atmosphere in a temperature range of 700° C. to 1000° C. and preferably 800° C. to 900° C.

As the non-oxidizing atmosphere, an inert atmosphere such as nitrogen (N₂) or argon (Ar) is preferable. When it is desired that the oxidation be further suppressed, a reducing atmosphere containing 1 vol % to 10 vol % of reducing gas such as hydrogen (H₂) with respect to inert gas is preferable.

The reason for limiting the baking temperature to be 700° C. to 1000° C. is as follows. It is not preferable that the baking temperature be lower than 700° C. because the decomposition and reaction of the organic compound contained in the dry material is not sufficiently progressed, the carbonization of the organic compound is insufficient, and the obtained decomposition and reaction products are formed as high-resistance organic decomposition products. On the other hand, when the baking temperature is higher than 1000° C., a component constituting the dry material, for example, lithium (Li) is evaporated and the composition is deviated. In addition, the grain growth of the dry material is promoted, the discharge capacity at a high charge-discharge rate is decreased, and it is difficult to realize sufficient charge-discharge rate performance.

The baking time is not particularly limited as long as the organic compound is sufficiently carbonized, and for example, is 0.1 hours to 10 hours.

During this baking process, Fe functions as a catalyst such that the organic compound is decomposed and reacts to form carbon during the heat treatment. As a result, Fe is attached on the surfaces of the LiₓA_{y}D_{z}PO₄ particles, and carbon derived from the organic compound is attached on the surfaces of the LiₓA_{y}D_{z}PO₄ particles on which Fe is attached to form a carbon coating film.

As a result, the surface-coated LiₓA_{y}D_{z}PO₄ particles or the aggregated particles are prepared, in which the surface-coated LiₓA_{y}D_{z}PO₄ particles contain Fe on surfaces of the LiₓA_{y}D_{z}PO₄ particles and include a carbon coating film with which the surfaces of the LiₓA_{y}D_{z}PO₄ particles containing Fe are coated, and the aggregated particles are obtained by allowing the surface-coated LiₓA_{y}D_{z}PO₄ particles to aggregate.

During the baking process, it is preferable that the dry material contain lithium because, along with an increase in baking time, lithium is diffused in the carbon coating film such that lithium is present inside the carbon coating film, and thus the conductivity of the carbon coating film is further improved.

However, it is not preferable that the baking time be excessively increased because abnormal grain growth occurs, the surface-coated LiₓA_{y}D_{z}PO₄ particles or the aggregated particles in which a part of lithium is defected are formed, and thus the performance of the surface-coated LiₓA_{y}D_{z}PO₄ particles or the aggregated particles is decreased. As a result, characteristics of a battery using the surface-coated LiₓA_{y}D_{z}PO₄ particles or the aggregated particles are decreased.

### Heat Treatment Process

In the heat treatment process, the surface-coated LiₓA_{y}D_{z}PO₄ particles or the aggregated particles are heated at a temperature of 40° C. to 500° C. and preferably 80° C. to 400° C. for 0.1 hours to 1000 hours, preferably 0.5 hours to 300 hours, and more preferably 0.5 hours to 200 hours.

The reason for limiting the heat treatment temperature and the time to the above-described ranges is as follows. By heating the surface-coated LiₓA_{y}D_{z}PO₄ particles or the aggregated particles under the above-described range conditions, heat energy of room temperature or higher is imparted thereto. As a result, Li and P contained in the particles of the dry material are eluted from the inside of the particles, the eluted Li and P cover the surfaces of the particles, and thus the elution of metal impurities other than Li from the particles can be suppressed.

An atmosphere in the heat treatment process is not particularly limited, and may be the air or a non-oxidizing atmosphere.

As a result, the surface-coated LiₓA_{y}D_{z}PO₄ particles or the aggregated particles having a desired average particle size can be obtained, in which the aggregated particles are obtained by allowing the surface-coated LiₓA_{y}D_{z}PO₄ particles to aggregate.

### Electrode-Forming Paste

An electrode-forming paste according to an embodiment of the invention includes the electrode material according to the embodiment, a conductive auxiliary agent, a binder, and a solvent.

The content of the electrode material is preferably 85% by mass to 98.5% by mass and more preferably 90% by mass to 98.5% by mass with respect to 100% by mass of the total mass of the electrode material, the conductive auxiliary agent, and the binder. By containing the electrode material in this range, an electrode having superior battery characteristics can be obtained.

The conductive auxiliary agent is not particularly limited as long as the conductivity can be imparted. For example, one or two or more elements selected from the group consisting of acetylene black, Ketjen black, Furnace black, and fibrous carbon such as vapor-grown carbon fiber (VGCF) or carbon nanotube can be used.

The content of the conductive auxiliary agent is preferably 0.1% by mass to 7% by mass, more preferably 0.2% by mass to 5% by mass, and still more preferably 0.5% by mass to 3% by mass with respect to 100% by mass of the total mass of the electrode material, the conductive auxiliary agent, and the binder.

It is not preferable that the content be less than 0.1% by mass because, when an electrode is formed using the electrode-forming paste according to the embodiment, the electron conductivity is insufficient, and thus the battery capacity or the charge-discharge rate is decreased. On the other hand, it is not preferable that the content be greater than 7% by mass because the electrode material in the electrode is relatively decreased, and the battery capacity of a lithium ion battery per unit volume is decreased.

The binder is not particularly limited, and for example, one or two or more elements selected from the group consisting of polyvinylidene fluoride (PVdF), polytetrafluoroethylene (PTFE), styrene-butadiene rubber, polyethylene, and polypropylene may be used.

The content of the binder is preferably 0.5% by mass to 10% by mass and more preferably 1% by mass to 7% by mass with respect to 100% by mass of the total mass of the electrode material, the conductive auxiliary agent, and the binder. It is not preferable that the content be less than 0.5% by mass because, when a coating film is formed using the paste according to the embodiment, a binding property between the coating film and a current collector is insufficient, and the coating film may be cracked or peeled off during the roll forming of the electrode or the like. In addition, the coating film may be peeled off from the current collector during the charging and discharging of a battery, and thus the battery capacity and the charge-discharge rate may be decreased. On the other hand, it is not preferable that the content be greater than 10% by mass because the internal resistance of the electrode material is increased, and the battery capacity at a high charge-discharge rate may be decreased.

The solvent is not particularly limited, and examples thereof include water; alcohols such as methanol, ethanol, 1-propanol, 2-propanol (isopropyl alcohol; IPA), butanol, pentanol, hexanol, octanol, or diacetone alcohol; esters such as ethyl acetate, butyl acetate, ethyl lactate, propylene glycol monomethyl ether acetate, propylene glycol monoethyl ether acetate, or γ-butyrolactone; ethers such as diethyl ether, ethylene glycol monomethyl ether (methyl cellosolve), ethylene glycol monoethyl ether (ethyl cellosolve), ethylene glycol monobutyl ether (butyl cellosolve), diethylene glycol monomethyl ether, or diethylene glycol monoethyl ether; ketones such as acetone, methyl ethyl ketone (MEK), methyl isobutyl ketone (MIBK), acetylacetone, or cyclohexanone; amides such as dimethyl formamide, N,N-dimethylacetoacetamide, or N-methyl pyrrolidone; and glycols such as ethylene glycol, diethylene glycol, or propylene glycol. These solvents may be used alone or in a combination of two or more kinds.

It is preferable that the solvent be mixed such that the solid content in the electrode-forming paste is 30% by mass to 70% by mass. In other words, the total content of the electrode material, the conductive auxiliary agent, and the binding agent in the electrode-forming paste is preferably 30% by mass to 70% by mass and more preferably 40% by mass to 60% by mass.

By mixing the electrode material, the conductive auxiliary agent, the binder, and the solvent with each other, the electrode-forming paste which is superior in forming an electrode and battery characteristics can be obtained.

A method of preparing the electrode-forming paste according to the embodiment is not particularly limited as long as the electrode material according to the embodiment, the conductive auxiliary agent, the binder, and the solvent can be uniformly mixed with this method. For example, a method using a kneading machine such as a ball mill, a sand mill, a planetary mixer, a paint shaker, or a homogenizer may be used.

### Electrode Plate

An electrode plate according to an embodiment of the invention is obtained by forming a cathode material layer containing the electrode material according to the embodiment on a current collector. This electrode plate is used for a cathode of a lithium ion battery.

In the embodiment, the electrode-forming paste is coated on a single surface of a metal foil which is a current collector, followed by drying. As a result, a metal foil with a single surface on which a coating film formed of a mixture of the electrode material, the conductive auxiliary agent, and the binder is formed is obtained.

Next, this coating film is pressed. As a result, an electrode including a cathode material layer on a single surface of the metal foil is prepared. Next, this electrode is heated at a temperature of 40° C. to 500° C. for 0.1 hours to 1000 hours to prepare the electrode plate according to the embodiment. Heat treatment conditions are completely the same as the heat treatment conditions of the method of preparing the above-described electrode material.

In this way, the electrode plate according to the embodiment can be prepared.

In this electrode plate, the electron conductivity of the cathode material layer can be improved.

### Lithium Ion Battery

A lithium ion battery according to an embodiment of the invention includes the electrode plate according to the embodiment.

That is, this lithium ion battery includes the electrode plate (cathode) according to the embodiment, an anode, and an electrolytic solution.

As the anode, an anode material such as metal Li, a carbon material, a Li alloy, or Li₄Ti₅O₁₂ can be used.

In order to prepare the anode, for example, graphite powder, a binder formed of a binder resin, a solvent, and optionally a conductive auxiliary agent such as carbon black are mixed with each other to obtain an anode-forming paste. This anode-forming paste is coated on a single surface of a metal foil, followed by drying. As a result, a metal foil with a single surface on which a coating film formed of a mixture of the electrode material and the binder resin is formed is obtained. This coating film is dried and then pressed. As a result, an electrode which includes an anode material layer including the electrode material on a single surface of the metal foil can be prepared.

The electrolytic solution can be prepared by mixing ethylene carbonate (EC) and ethyl methyl carbonate (EMC) at a volume ratio of 1:1 to obtain a mixed solvent and dissolving lithium hexafluorophosphate (LiPF₆) in the mixed solvent at a concentration of, for example, 1 mol/dm³. A separator is required for this electrolytic solution, and a solid electrolyte may be used instead of the electrolytic solution and the separator.

In the lithium ion battery according to the embodiment, by using the electrode plate according to the embodiment as a cathode, the insertion and extraction of Li are improved, and thus stable charge-discharge cycling characteristics and high stability can be realized.

As described above, the electrode material according to the embodiment includes surface-coated LiₓA_{y}D_{z}PO₄ particles or aggregated particles, in which the surface-coated LiₓA_{y}D_{z}PO₄ particles contain Fe on surfaces of the LiₓA_{y}D_{z}PO₄ particles and include a carbon coating film with which the surfaces of the LiₓA_{y}D_{z}PO₄ particles containing Fe are coated, and the aggregated particles are obtained by allowing surface-coated LiₓA_{y}D_{z}PO₄ particles to aggregate. In the electrode material, the surface-coated LiₓA_{y}D_{z}PO₄ particles or the aggregated particles have a Li elution amount of 200 ppm to 700 ppm and a P elution amount of 500 ppm to 2000 ppm when being dipped in a sulfuric acid solution (pH=4) for 24 hours. As a result, the elution of metal impurities other than Li from the surface-coated LiₓA_{y}D_{z}PO₄ particles or the aggregated particles can be suppressed.

When the electrode material according to the embodiment further contains manganese oxide, the electron conductivity can be further improved.

The electrode-forming paste according to the embodiment includes: the electrode material according to the embodiment; a conductive auxiliary agent; a binding agent; and a solvent. As a result, when an electrode is obtained by forming a cathode material layer containing an electrode material on a current collector using the electrode-forming paste, the elution of metal impurities other than Li in this electrode can be suppressed.

The electrode plate according to the embodiment is obtained by forming a cathode material layer containing the above-described electrode material on a current collector. As a result, the elution of metal impurities other than Li can be suppressed.

The lithium ion battery according to the embodiment includes the electrode plate according to the embodiment. As a result, the elution of metal impurities other than Li can be suppressed, and thus the durability of a lithium ion battery can be improved.

The method of producing an electrode material according to the embodiment includes: mixing LiₓA_{y}D_{z}PO₄ particles, an organic compound, and either or both of an iron source and a precursor material of lithium iron phosphate with a solvent to prepare a slurry; drying the slurry to prepare a dry material; baking the dry material in a non-oxidizing atmosphere to prepare surface-coated LiₓA_{y}D_{z}PO₄ particles or aggregated particles, in which the surface-coated LiₓA_{y}D_{z}PO₄ particles contain Fe on surfaces of the LiₓA_{y}D_{z}PO₄ particles and include a carbon coating film with which the surfaces of the LiₓA_{y}D_{z}PO₄ particles containing Fe are coated, and the aggregated particles are obtained by allowing the surface-coated LiₓA_{y}D_{z}PO₄ particles to aggregate; and heating either the surface-coated LiₓA_{y}D_{z}PO₄ particles or the aggregated particles at a temperature of 40° C. to 500° C. for 0.1 hours to 1000 hours. As a result, an electrode material capable of suppressing the elution of metal impurities other than Li can be easily produced.

The method of producing the electrode plate according to the embodiment includes: coating the electrode-forming paste on a single surface of a metal foil which is a current collector and drying the electrode-forming paste; obtaining a metal foil with a single surface on which a coating film formed of a mixture of the electrode material, the conductive auxiliary agent, and the binder is formed; pressing this coating film to prepare an electrode including a cathode material layer on a single surface of the metal foil; and heating this electrode at a temperature of 40° C. to 500° C. for 0.1 hours to 1000 hours. As a result, an electrode plate capable of suppressing the elution of metal impurities other than Li can be easily produced.

### EXAMPLES

Hereinafter, the invention will be described using Examples and Comparative Examples. However, the invention is not limited to these examples.

### Example 1

### Preparation of Electrode Material

4 mol of lithium acetate (LiCH₃COO), 2 mol of manganese sulfate (II) (MnSO₄), and 2 mol of phosphoric acid (H₃PO₄) were mixed with 2 L (liter) of water such that the total amount was 4 L. As a result, a uniform slurry mixture was prepared.

Next, this mixture was placed in a pressure-resistant sealed container having a volume of 8 L, followed by hydrothermal synthesis at 120° C. for 1 hour.

Next, the obtained precipitates were washed with water to obtain LiMnPO₄ particles.

Next, 60 g (in terms of solid content) of the LiMnPO₄ particles, 3 g of polyethylene glycol as the organic compound, and 60 g of water as the solvent were mixed with each other to prepare a solution for coating the surfaces of the LiMnPO₄ particles with LiFePO₄, the solution including a Li source, a Fe source, and a PO₄ source. This solution was dispersed for 12 hours with a ball mill by using 500 g of zirconia balls having a diameter of 5 mm as medium particles. As a result, a uniform slurry was prepared.

In the solution including a Li source, a Fe source, and a PO₄ source, the mass of each of the Li source, the Fe source, and the PO₄ source was set such that the content of the LiFePo₄ particles was 5% by mass with respect to the total mass of the LiMnPO₄ particles and the LiFePO₄ particles.

Next, this slurry was sprayed and dried in the air at 180° C. to obtain LiMnPO₄ particles of which the surfaces were coated with polyethylene glycol.

Next, the LiMnPO₄ particles of which the surfaces are coated with polyethylene glycol were calcined in a nitrogen (N₂) atmosphere at 700° C. for 1 hour. As a result, surface-coated LiMnPO₄ particles including a carbon coating film for coating the surfaces and containing Fe on the particle surfaces were obtained.

Next, these LiMnPO₄ particles were heated in the air at 40° C. for 0.5 hours. As a result, an electrode material (A1) of Example 1 including the surface-coated LiMnPO₄ particles having an average particle size of 55 nm was obtained.

### Evaluation of Electrode Material

When the electrode material (A1) was observed using a scanning electron microscope (SEM) and a transmission electron microscope (TEM), it was found that the surfaces of the LiMnPO₄ particles were coated with the thin-film-shaped carbon coating film.

3 g of the electrode material (A1) was dipped in 30 g of sulfuric acid solution having a pH of 4 at 25° C. for 24 hours, followed by solid-liquid separation. The Fe elution amount, the Li elution amount, and the Pelution amount in the obtained solution were measured using an ICP spectrometer (manufactured by Seiko Instruments Inc.).

The evaluation results of the electrode material are shown in Tables 1 and 2.

### Preparation of Paste

The electrode material (A1), polyvinylidene fluoride (PVdF) as the binder, and acetylene black (AB) as the conductive auxiliary agent were mixed with each other with a mass ratio of 90:5:5, and N-methyl-2-pyrrolidone (NMP) as the solvent was added thereto to impart fluidity. As a result, a paste of Example 1 was prepared.

### Preparation of Electrode Plate

The paste was coated on an aluminum (Al) foil having a thickness of 15 followed by drying. Next, the aluminum foil was pressed at a pressure of 600 kgf/cm². An electrode plate of a lithium ion battery of Example 1 was prepared as a cathode.

### Preparation of Lithium Ion Battery

Relative to the cathode of the lithium ion battery, lithium metal was disposed as an anode, and a separator formed of porous polypropylene was disposed between the cathode and the anode. As a result, a battery member was obtained.

Meanwhile, ethylene carbonate (EC) and ethyl methyl carbonate (EMC) were mixed at a volume ratio of 1:1 to obtain a mixed solvent, and lithium hexafluorophosphate (LiPF6) was dissolved in the mixed solvent at a concentration of 1 mol/dm³. As a result, an electrolytic solution was prepared.

Next, the battery member was dipped in the electrolytic solution. As a result, a lithium ion battery of Example 1 was prepared.

### Evaluation of Lithium Ion Battery

The charge-discharge characteristics of the lithium ion battery were evaluated.

The lithium ion battery was charged with a constant current at 60° C. until the charge voltage was 4.2 V at a current value of 1 C, and then was charged with a constant voltage. Once the current value was 0.01 C, charging was finished. Next, the lithium ion battery was discharged at a discharge current of 1 C. Once the battery voltage was 2.5 V, discharging was finished. At this time, the discharge capacity was measured as an initial discharge capacity.

In addition, under the same conditions, charging and discharging were repeated. The discharge capacity in a 300-th cycle was measured, and the capacity retention relative to the initial discharge capacity was calculated.

The evaluation results of the lithium ion battery of Example 1 are shown in Table 3.

### Example 2

An electrode material, a paste, an electrode plate, and a lithium ion battery were obtained with the same method as that of Example 1, except that the content of the LiFePo₄ particles in the solution including a Li source, a Fe source, and a PO₄ source was changed from 5% by mass to 3% by mass.

The above-described components were measured and evaluated with the same method as that of Example 1. The evaluation results of the electrode material and the lithium ion battery of Example 2 are shown in Tables 1 to 3.

### Example 3

An electrode material, a paste, an electrode plate, and a lithium ion battery were obtained with the same method as that of Example 1, except that the heat treatment time was changed from 0.5 hours to 200 hours.

The above-described components were measured and evaluated with the same method as that of Example 1. The evaluation results of the electrode material and the lithium ion battery of Example 3 are shown in Tables 1 to 3.

### Example 4

An electrode material, a paste, an electrode plate, and a lithium ion battery were obtained with the same method as that of Example 1, except that the heat treatment temperature was changed from 40° C. to 200° C.

The above-described components were measured and evaluated with the same method as that of Example 1. The evaluation results of the electrode material and the lithium ion battery of Example 4 are shown in Tables 1 to 3.

### Example 5

An electrode material, a paste, an electrode plate, and a lithium ion battery were obtained with the same method as that of Example 1, except that the content of the LiFePO₄ particles in the solution including a Li source, a Fe source, and a PO₄ source was changed from 5% by mass to 8% by mass.

The above-described components were measured and evaluated with the same method as that of Example 1. The evaluation results of the electrode material and the lithium ion battery of Example 5 are shown in Tables 1 to 3.

### Example 6

An electrode material, a paste, an electrode plate, and a lithium ion battery were obtained with the same method as that of Example 1, except that, when the LiMnPO₄ particles, polyethylene glycol, water, and the solution including a Li source, a Fe source, and a PO₄ source were dispersed, 0.5% by mass of manganese oxide with respect to the LiMnPO₄ particles was added.

The above-described components were measured and evaluated with the same method as that of Example 1. The evaluation results of the electrode material and the lithium ion battery of Example 6 are shown in Tables 1 to 3.

### Comparative Example 1

An electrode material, a paste, an electrode plate, and a lithium ion battery were obtained with the same method as that of Example 1, except that, when the LiMnPO₄ particles, polyethylene glycol, and water were dispersed, the solution including a Li source, a Fe source, and a PO₄ source was not added; and the heat treatment was not performed.

The above-described components were measured and evaluated with the same method as that of Example 1. The evaluation results of the electrode material and the lithium ion battery of Comparative Example 1 are shown in Tables 1 to 3.

### Comparative Example 2

An electrode material, a paste, an electrode plate, and a lithium ion battery were obtained with the same method as that of Example 1, except that the heat treatment was not performed.

The above-described components were measured and evaluated with the same method as that of Example 1. The evaluation results of the electrode material and the lithium ion battery of Comparative Example 2 are shown in Tables 1 to 3.

### Comparative Example 3

An electrode material, a paste, an electrode plate, and a lithium ion battery were obtained with the same method as that of Example 1, except that, when the LiMnPO₄ particles, polyethylene glycol, water, and the solution including a Li source, a Fe source, and a PO₄ source were dispersed, 0.5% by mass of manganese oxide with respect to the LiMnPO₄ particles was added; and the heat treatment was not performed.

The above-described components were measured and evaluated with the same method as that of Example 1. The evaluation results of the electrode material and the lithium ion battery of Comparative Example 3 are shown in Tables 1 to 3.

TABLE 1

| | | Addition | | |
|---|---|---|---|---|
| | Addition Amount | Amount | Heat | Heat |
| | (%) of Fe source | (mass %) of | Treatment | Treatment |
| | (LFP/(LFP + | Manganese | Temperature | Time |
| | LMP)) | Oxide | (° C.) | (hr) |
| Example 1 | 5 | — | 40 | 0.5 |
| Example 2 | 3 | — | 40 | 0.5 |
| Example 3 | 5 | — | 40 | 200 |
| Example 4 | 5 | — | 200 | 0.5 |
| Example 5 | 8 | — | 40 | 0.5 |
| Example 6 | 5 | 0.5 | 40 | 0.5 |
| Comparative | — | — | — | — |
| Example 1 | | | | |
| Comparative | 5 | — | — | — |
| Example 2 | | | | |
| Comparative | — | 0.5 | — | — |
| Example 3 | | | | |

(Note)
LFP: LiFePO₄
LMP: LiMnPO₄

TABLE 2

| | Elution Amounts | | Li | P | |
|---|---|---|---|---|---|
| | of Metal Impurities | | Elution | Elution | |
| | Mn | Fe | Amount | Amount | |
| | (ppm) | (ppm) | (ppm) | (ppm) | pH |
| Example 1 | 18 | 5 | 432 | 1352 | 8.9 |
| Example 2 | 24 | 12 | 415 | 1221 | 8.4 |
| Example 3 | 11 | 9 | 621 | 1652 | 8.3 |
| Example 4 | 9 | 7 | 635 | 1592 | 8.7 |
| Example 5 | 13 | 10 | 450 | 1250 | 8.5 |
| Example 6 | 35 | 4 | 595 | 1351 | 8.2 |
| Comparative | 162 | 92 | 133 | 411 | 6.5 |
| Example 1 | | | | | |
| Comparative | 142 | 76 | 181 | 525 | 6.3 |
| Example 2 | | | | | |
| Comparative | 131 | 85 | 121 | 425 | 6.8 |
| Example 3 | | | | | |

TABLE 3

| | Initial Discharge | Discharge Capacity |
|---|---|---|
| | Capacity (mAh) | Retention (%) |
| Example 1 | 8.95 | 89 |
| Example 2 | 8.65 | 83 |
| Example 3 | 8.29 | 87 |
| Example 4 | 8.82 | 88 |
| Example 5 | 8.75 | 85 |
| Example 6 | 8.98 | 90 |
| Comparative | 8.17 | 57 |
| Example 1 | | |
| Comparative | 8.25 | 67 |
| Example 2 | | |
| Comparative | 8.31 | 65 |
| Example 3 | | |

It was found from the above results that, in the electrode materials of Examples 1 to 6, the Mn elution amount and the Fe elution amount were effectively suppressed by controlling the Li elution amount to be 200 ppm to 700 ppm and the P elution amount to be 500 ppm to 2000 ppm, Li and P being eluted from the electrode material into the sulfuric acid solution.

In addition, it was found that the capacity retention after 300 cycles of charging and discharging in an environment of 60° C. was higher than 80%, and superior charge-discharge characteristics were exhibited.

The reason is presumed to be that the elution of Fe and Mn during cycling was suppressed, the electrodeposition of Fe-based impurities and Mn-based impurities on SEI fracture and the anode was suppressed, and thus deterioration in capacity is suppressed.

In addition, the reason why the pH of the solution after the elution was 8.3 to 8.9 was presumed to be that the hydrogen ion concentration of the solution was decreased, and a large amount of Li which was shifted to the alkali side was eluted.

On the other hand, in the electrode material of Comparative Examples 1 to 3, the Li elution amount eluted in the sulfuric acid solution was 200 ppm or less. As a result, it was found that the function of suppressing the Fe elution amount and the Mn elution amount did not work, the capacity retention after 300 cycles of charging and discharging in an environment of 60° C. was 70% or lower, and the charge-discharge cycling characteristics were significantly decreased.

The reason is presumed to be that the elution of Fe and Mn during cycling was not suppressed; however, the electrodeposition of Mn-based impurities on SEI fracture and the anode was increased, and thus deterioration in capacity is significant.

In addition, the reason why the pH of the solution after the elution was 7.0 or lower was presumed to be that the hydrogen ion concentration of the solution was decreased; however, the amount of Li which was shifted to the alkali side was small.

It was found from the above results that in the surface-coated LiMnPO₄ particles of Examples 1 to 6, deterioration in capacity after repeating the charging and discharging cycles in a high-temperature environment of 60° C. was suppressed, and charge-discharge cycling characteristics can be improved during use of a secondary battery at a high temperature.

The electrode material according to the invention includes surface-coated LiₓA_{y}D_{z}PO₄ particles or aggregated particles, in which the surface-coated LiₓA_{y}D_{z}PO₄ particles contain Fe on surfaces of the LiₓA_{y}D_{z}PO₄ particles and include a carbon coating film with which the surfaces of the LiₓA_{y}D_{z}PO₄ particles containing Fe are coated, and the aggregated particles are obtained by allowing surface-coated LiₓA_{y}D_{z}PO₄ particles to aggregate. In the electrode material, the surface-coated LiₓA_{y}D_{z}PO₄ particles or the aggregated particles have a Li elution amount of 200 ppm to 700 ppm and a P elution amount of 500 ppm to 2000 ppm when being dipped in a sulfuric acid solution (pH=4) for 24 hours. As a result, the elution of metal impurities other than Li from the surface-coated LiₓA_{y}D_{z}PO₄ particles or the aggregated particles can be suppressed. Accordingly, the electrode material according to the present invention is applicable to a next-generation secondary battery in which a decrease in size and weight and an increase in capacity are expected, and when being used for a next-generation secondary battery, the effects thereof are significantly high.

1. An electrode material, comprising
surface-coated LiₓA_{y}D_{z}PO₄ particles that contain Fe on surfaces of LiₓA_{y}D_{z}PO₄ (wherein A represents one or two or more elements selected from the group consisting of Co, Mn, Ni, Cu, and Cr; D represents one or two or more elements selected from the group consisting of Mg, Ca, Sr, Ba, Ti, Zn, B, Al, Ga, In, Si, Ge, Sc, Y, and rare earth elements; 0<x≦2; 0<y≦1; and 0≦z≦1.5) particles and include a carbon coating film with which the surfaces of the LiₓA_{y}D_{z}PO₄ particles containing Fe are coated,
wherein the surface-coated LiₓA_{y}D_{z}PO₄ particles have a Li elution amount of 200 ppm to 700 ppm and a P elution amount of 500 ppm to 2000 ppm when being dipped in a sulfuric acid solution having a pH of 4 for 24 hours.

2. An electrode material, comprising
aggregated particles that are obtained by allowing surface-coated LiₓA_{y}D_{z}PO₄ particles to aggregate,
wherein the surface-coated LiₓA_{y}D_{z}PO₄ particles contain Fe on surfaces of LiₓA_{y}D_{z}PO₄ (wherein A represents one or two or more elements selected from the group consisting of Co, Mn, Ni, Cu, and Cr; D represents one or two or more elements selected from the group consisting of Mg, Ca, Sr, Ba, Ti, Zn, B, Al, Ga, In, Si, Ge, Sc, Y, and rare earth elements; 0<x≦2; 0<y≦1; and 0≦z≦1.5) particles and include a carbon coating film with which the surfaces of the LiₓA_{y}D_{z}PO₄ particles containing Fe are coated, and
the aggregated particles have a Li elution amount of 200 ppm to 700 ppm and a P elution amount of 500 ppm to 2000 ppm when being dipped in a sulfuric acid solution having a pH of 4 for 24 hours.

3. The electrode material according to claim 1, further comprising manganese oxide.

4. An electrode-forming paste, comprising:
the electrode material according to claim 1;
a conductive auxiliary agent;
a binding agent; and
a solvent.

5. An electrode plate which is obtained by forming a cathode material layer containing the electrode material according to claim 1 on a current collector.

6. A lithium ion battery, comprising
the electrode plate according to claim 5.

7. A method of producing an electrode material, comprising:
mixing LiₓA_{y}D_{z}PO₄ (wherein A represents one or two or more elements selected from the group consisting of Co, Mn, Ni, Cu, and Cr; D represents one or two or more elements selected from the group consisting of Mg, Ca, Sr, Ba, Ti, Zn, B, Al, Ga, In, Si, Ge, Sc, Y, and rare earth elements; 0<x≦2; 0<y≦1; and 0≦z≦1.5) particles, an organic compound, and either or both of an iron source and a precursor material of lithium iron phosphate with a solvent to prepare a slurry;
drying the slurry to prepare a dry material;
baking the dry material in a non-oxidizing atmosphere to prepare surface-coated LiₓA_{y}D_{z}PO₄ particles or aggregated particles, in which the surface-coated LiₓA_{y}D_{z}PO₄ particles contain Fe on surfaces of the LiₓA_{y}D_{z}PO₄ particles and include a carbon coating film with which the surfaces of the LiₓA_{y}D_{z}PO₄ particles containing Fe are coated, and the aggregated particles are obtained by allowing the surface-coated LiₓA_{y}D_{z}PO₄ particles to aggregate; and
heating either the surface-coated LiₓA_{y}D_{z}PO₄ particles or the aggregated particles at a temperature of 40° C. to 500° C. for 0.1 hours to 1000 hours
